(19) United States
(12) Patent Application Publication
(10) Pub. No.: US 2007/0266937 A1
(43) Pub. Date: Nov. 22, 2007

(54) Device for Spreading Adhesive

(76) Inventors: Giovanni Fascianella, Sint-Pieters-Leeuw (BE); Roland Declerq, Lokeren (BE)

Correspondence Address: SHEEHAN PHINNEY BASS & GREEN, PA;c/o PETER NIEVES, 1000 ELM STREET, MANCHESTER, NH, 03105-3701, US

(21) Appl. No.: 10/578,045

(22) PCT Filed: Oct. 29, 2004
(86) PCT No.: PCT/EP04/52733

§ 371 Date: Feb. 27, 2007

(30) Foreign Application Priority Data
Oct. 31, 2003 (BE) PCT/BE03/00183

(51) Int. Cl. B05C 3/00

(52) U.S. Cl. 118/400

(57) ABSTRACT

The invention relates to a device (1), for spreading adhesive for floor coverings, comprising a quadrilateral housing (2) open on at least the lower face thereof, said housing (2) being provided with a handle (4), arranged on a fourth vertical wall and a toothed lower edge (5), arranged on a first vertical wall, opposite that provided with said handle (4).

The present invention relates to a device for spreading adhesive for floor coverings, comprising a quadrangular housing open at least on its lower face, said housing comprising at least a first, a second and a third vertical wall, said second and third vertical walls being opposite one another and each of said vertical walls comprising a lower edge and an upper edge, said housing comprising at least one handle and at least said first vertical wall comprising teeth on the lower edge.

Such a device is for example known from the German utility model G 03 09 329.2 which discloses a casing provided with a handle allowing towing of the casing, which casing has a fourth wall provided with teeth making it possible to spread strips of adhesive directly on the floor and form grooves in it. It is in fact well known that persons skilled in the art, when they wish to spread adhesive, use a toothed spatula that is also referred to as an adhesive comb in order to form grooves in the layer of adhesive and allow better adhesion of the floor covering to be applied. This device comprises interchangeable one-piece casing modules, to be fixed to the handle, with a width lying in the range 30 cm to 95 cm.

Unfortunately, such a device is cumbersome to use and transport; in fact it forces persons skilled in the art, each time they wish to lay another size of tile, to change casing module and consequently empty it, clean it and replace it with another. It is well known that spreading 90 cm-wide strips of adhesive in order to lay for example 10 cm tiles is entirely impractical and leads to a poor quality of work since persons skilled in the art must go above 80 cm of adhesive in order to lay the first, and then lack accuracy and freedom of movement. Moreover, the few modules provided do not allow the spreading of strips of adhesive of any desired width to be provided. This is because it is only possible to spread on the floor strips of adhesive of a width equal to the width of the various existing modules. Persons skilled in the art, when they move around on the worksite, must make provision to provide themselves with all the casings, which can present a considerable load and especially if the tiling to be laid is for example a mosaic tiling requiring tiles of various sizes. Furthermore, the floors to be covered are not necessarily spacious surfaces and it is often a nuisance to have to interchange the casing when in the middle of a surface on the worksite where part is covered with freshly laid covering, piles of tools, a stock of covering to be laid, a pre-pasted surface, etc.

Moreover, in this kind of device, if a strip of adhesive is not uniform and/or is poorly pasted, it will be necessary for persons skilled in the art to scrape off all the adhesive already laid by hand, put it back in the casing and start their pasting again.

The aim of the present invention is to overcome these drawbacks by allowing the user to work more accurately, more quickly and more easily whilst requiring less work space and by spreading strips of adhesive whose width is adjustable very simply, without requiring dismantling, emptying, cleaning, transportation and handling of excessively heavy and cumbersome objects.

To this end, the present invention provides a device as stated at the beginning, characterised in that said vertical walls have an adjustable length provided in order to be adapted to a tile dimension.

This is because the device according to the invention makes it possible to spread strips of adhesive of variable width. The user can for example place a tile inside said device and use it to set the width of the strip of adhesive by closing up or opening out the vertical walls until they come into contact with the sides of the tile. Moreover, if persons skilled in the art have to change tile size for the pattern to be laid, all that is necessary is to close up or open out the vertical walls again. This adjustment of the width of the device (length of the first vertical wall) requires neither emptying of the adhesive contained in said device, nor manipulation of heavy and cumbersome casings, nor manipulation of a handle, which is also cumbersome. All that is needed is to bring the lateral walls closer to one another or move them further away from one another by sliding. Thus, the user can deposit a large amount of adhesive inside the housing without thinking that he will have to empty it all during adhesive spreading. Moreover, the presence of solely three walls allows simplicity of use. This is because, if persons skilled in the art carry out a non-uniform pasting because of some disruption in their work, instead of having to scrape off all the adhesive already deposited by means of a trowel and put it all back in the casing, they just need to lift up the device according to the invention, leaving all its adhesive where it is, carry it away and replace it at the location of the pasting non-uniformity, without scraping off or removing the adhesive already laid. Then, they pull the device according to the invention until they reach the location where they left its adhesive and continue their pasting without stopping. As it were, they start just the grooving again since the surplus adhesive poses no problem thanks to the absence of a wall at the front.

In a particular embodiment, the device according to the invention comprises a fourth vertical wall.

This embodiment is particularly advantageous in the case of particularly liquid adhesive which is more difficult to confine in a three-wall device.

Advantageously, at least one of said vertical walls comprises teeth on the upperedge.

The presence of an upper or lower edge provided with teeth makes it possible to obtain a more flexible device where the walls can be turned upside down, which walls can for example have a tooth size different at the top and at the bottom in order to obtain for example different groovings which may be required for one type of covering or for another.

In a highly advantageous embodiment of the invention, the device comprises a U-shaped component comprising an upper opening and a lower support surface, said U-shaped component being provided in order to be disposed on the lower edge of said second and third vertical walls of said housing.

In a variant according to the invention, the second and third vertical walls have, at least at the lower edge, a protuberance extending downwards folded upwards. This protuberance has a lower support surface and is provided in order to allow easier sliding of said housing over said floor during said adhesive spreading.

These support surfaces at the lower edge of the second and third vertical walls act as runners since, like wood, all steel, stainless steel and similar has a direction. This direction makes it possible to define one surface smoother than another which will, during the pulling of the device according to the invention, allow the latter to slide directly on the floor in order to alleviate the strain on persons skilled in the art.

If so desired, the invention also makes provision that this support surface can be present on both the upper and lower edge.

Moreover, these support surfaces make it possible to avoid wear of the teeth since the latter do not rub against the floor. In the case of a U-shaped component, the latter is easily replaceable when it is worn out since the lower edge is simply pushed inside.

Advantageously, the lower support surfaces of the second and third walls are situated lower than said lower edges of the first wall and/or of the fourth wall, when the device is assembled.

This is because, when the device is used, if the edges of the second and third vertical walls are in contact with the floor, the weight of the adhesive spreading device according to the invention is mainly distributed on the aforementioned folds making it possible to reduce the rubbing of the walls which do not have this protuberance. Moreover, this device allows a pre-pasting, which is also referred to as application of a first layer, of a thickness that will be exactly equal to the difference in height between a lower part of the teeth of the fourth and/or of the first vertical wall and the folds of the second and third vertical walls.

Advantageously, the teeth of the lower or upper edge are teeth which are, for example, either situated on at least one edge of an interchangeable plate, which is provided in order to be fixed at the lower or upper edge, or both, of at least one of said vertical walls, or integral with said edge of at least one of said vertical walls.

The interchangeable plates can have adjustable lengths for a better adaptation on the vertical walls of adjustable length.

Moreover, it must be envisaged that advantageously the teeth have a different height and/or width and/or spacing with respect to one another.

In a particularly simple embodiment according to the invention, the fourth vertical wall comprises the handle on an external face.

In a particularly flexible and advantageous embodiment, two vertical walls comprise an identical or different handle.

This makes it possible to quickly interchange the first and/or fourth vertical wall and the second and third vertical wall without dismantling the device since it is consequently sufficient to turn it by a quarter of a turn with respect to the direction of pulling of the device according to the invention.

Preferably, the handle is situated on the vertical wall at a position such that, when the wall is turned upside down, the device according to the invention can still be pulled adequately.

Advantageously, in which said handle is adjustable in length.

In one embodiment, the handle of the device for spreading adhesive for floor coverings connects the upper edges of the second and third vertical walls.

Disposing the handle at this location has made it possible to obtain a device of greater rigidity; this handle in effect acts as a strengthening bar, and is preferably adjustable, namely it can be drawn out or closed up at the same time as the vertical walls. The disposition of the handle at this location also makes it possible to avoid the front of the device according to the invention lifting up.

Advantageously, a second handle, adjustable in length, connects the upper edges of the second and third vertical walls. This adds to the advantages mentioned just above and allows more flexibility during pulling. According to requirements, the user can use the first situated towards the rear or the second situated for example towards the front.

The device according to the invention also comprises a bar, one end of which has a shape provided to be associated with the handle of the housing, in an articulated and removable manner. The bar serves as a control column for the device, allowing persons skilled in the art to not always work kneeling. Advantageously, the bar is telescopic.

More specifically, the teeth have a height (h) and a width (w) in mm (h×w) chosen from amongst the following: 6×6, 8×8, 8×10, 10×12, 12×14, and a spacing by a distance (in mm) chosen from amongst the following: 6, 8, 10, 12 and 14; or a diameter of 6, 8, 10, 12, 14 mm and a spacing by a distance (in mm) chosen from amongst the following: 6, 8, 10, 12 and 14.

The shape of the teeth is advantageously chosen from amongst the following shapes: half-moon, rectangle, semi-ellipse and other similar ones.

Typically, the length of the vertical walls lies in the range 30 cm to 80 cm, and preferably 40 cm to 72 cm.

In a particular embodiment, the device comprises a masking plate provided to be affixed to the internal face of at least one vertical wall provided with teeth, the masking plate being provided to mask at least one tooth. It is sometimes necessary to have teeth wider than what has been provided according to the invention, consequently, it is possible by means of this plate for example to mask alternate teeth, to mask all the teeth if a straight edge is desired and any other conceivable possibility in the same range.

Advantageously, a panel is provided to be affixed to the internal face of at least one vertical wall provided with teeth, the panel being provided to slide vertically so as to vary the height of the teeth. It is sometimes required to affix a 2 cm-thick layer of adhesive, only the first centimetre of which must be grooved. With the device according to the invention, this is possible, since the fourth and second vertical walls can come down lower than the second and third vertical walls, and it is therefore sufficient to impose one centimetre of level difference and position the panel in order to reduce the depth of the teeth to 1 cm.

According to the invention, a counterweight is provided to be disposed in the region of the first vertical wall, preferably on the upper edge of the first vertical wall. In the case of a very large user or a heavy and very thick adhesive, it can be advantageous to have a weight to affix to said first wall in order to avoid unexpected lifting. The weight is disposed straddling the wall by appropriate fixing means.

In particular, the device according to the invention consists of a material chosen from the group consisting of stainless steel, galvanised steel, rigid plastic, ceramic and mixtures thereof provided that these materials are sufficiently heavy to avoid the device according to the invention lifting during pulling.

Other embodiments of the device according to the invention are given in the accompanying claims.

Other details and special features of the invention will emerge from the description given hereinafter, on a non-limiting basis, making reference to the accompanying drawings.

FIG. 1 illustrates a device for spreading adhesive for floor coverings according to the present invention and its control by a user.

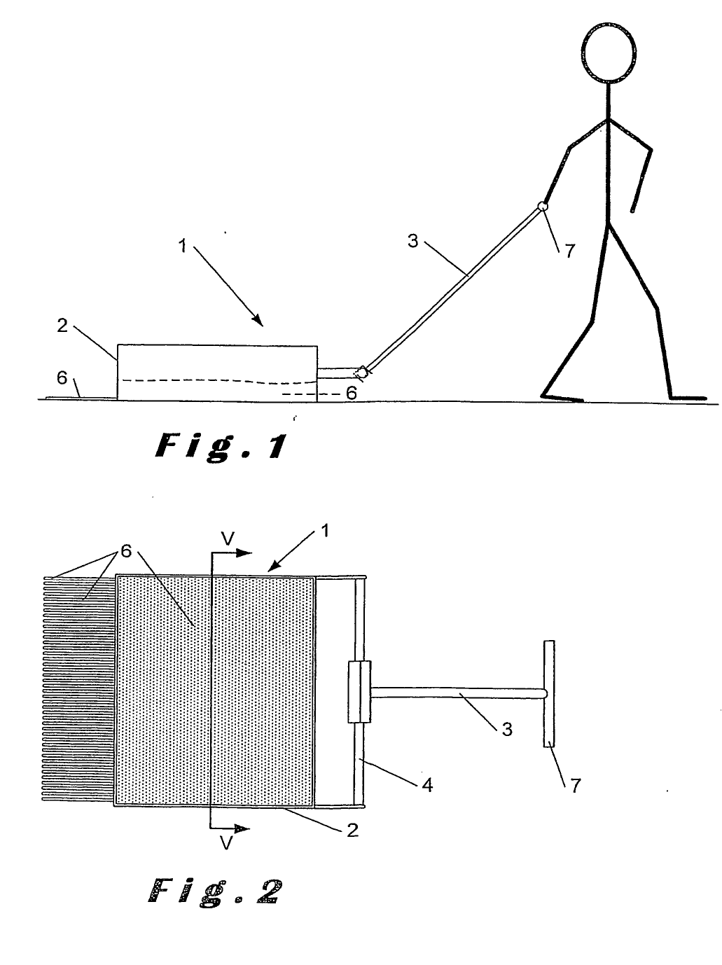

FIG. 2 is an overhead view of a device according to the invention showing the layer of adhesive deposited by the pulling of said device.

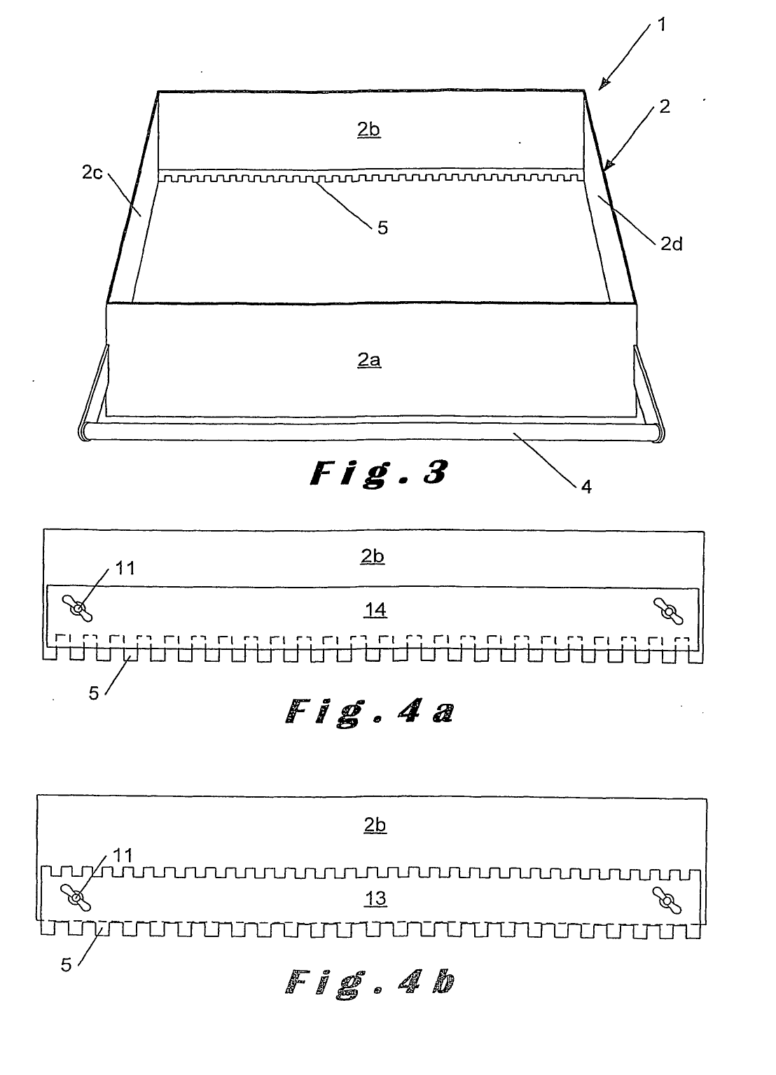

FIG. 3 is a perspective view of a simple embodiment of the device according to the invention.

FIG. 4a is a front view of an embodiment of the device according to the invention comprising a panel making it possible to adjust the height of the teeth. FIG. 4b is a front view of an embodiment of the device according to the invention in which the teeth are placed on an interchangeable plate which is adjustable in height.

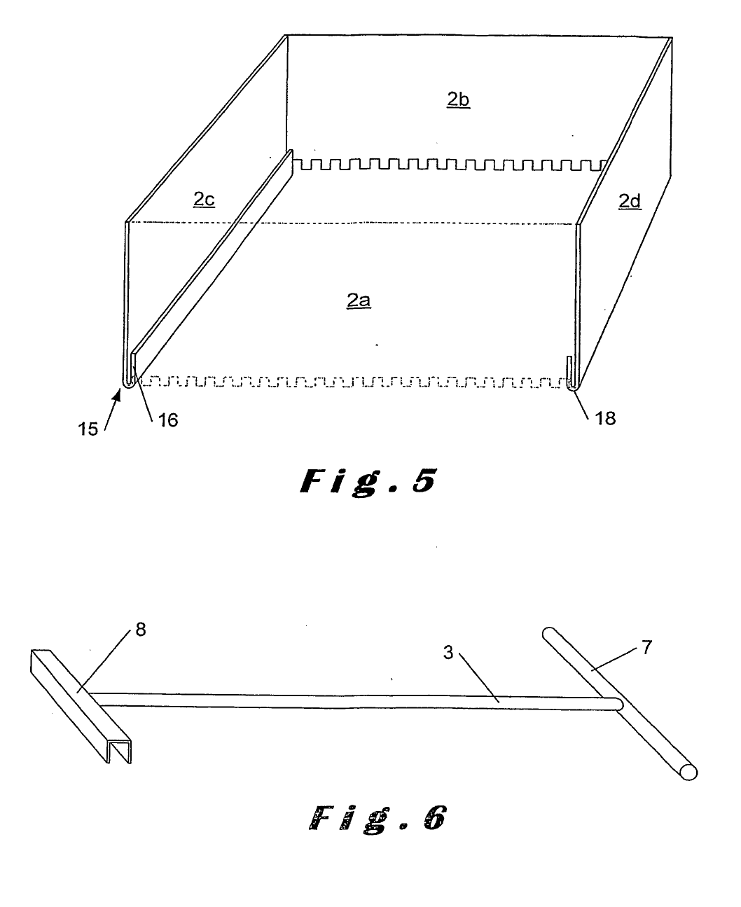

FIG. 5 is a perspective view of an embodiment of the device according to the invention illustrating the support surfaces of the vertical walls.

FIG. 6 illustrates an embodiment of a bar provided for pulling the device according to the invention.

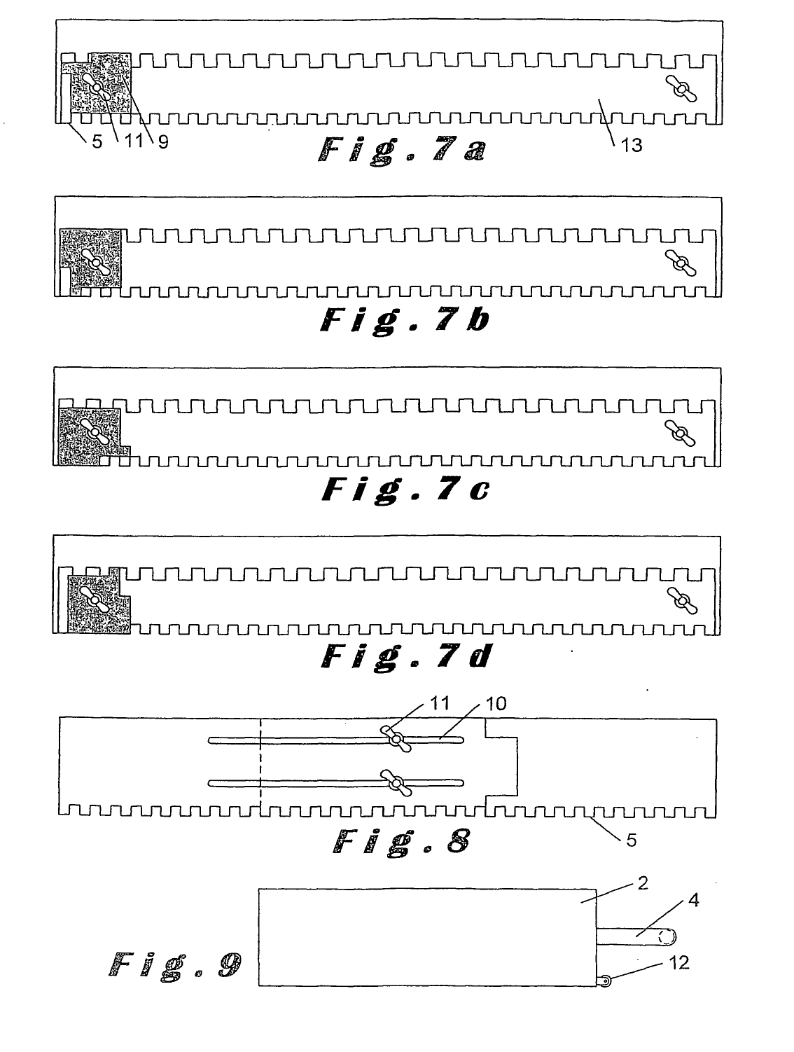

FIGS. 7a to 7d are front views of an embodiment of the toothed edge and a panel provided to mask or not mask at least one tooth of the lower edge of the housing of the device of the invention.

FIG. 8 is a front view of an embodiment, in which the housing has an adjustable width.

FIG. 9 is a side view of an embodiment of the device which comprises castors.

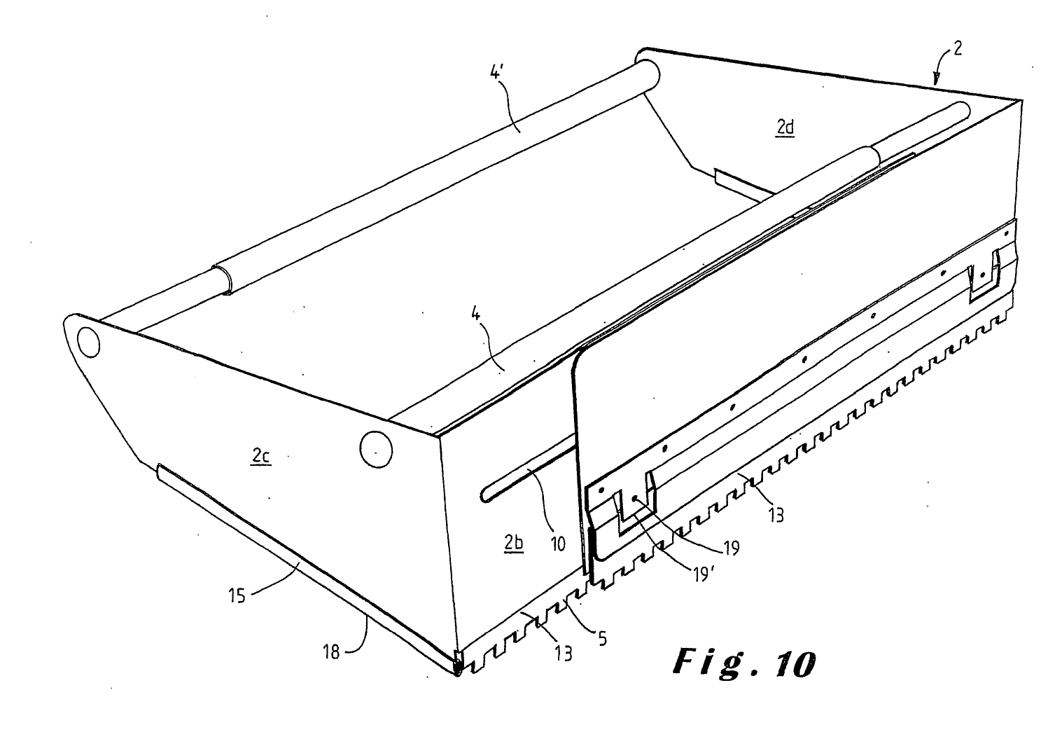

FIG. 10 is a perspective view of the most preferential embodiment of the device according to the invention.

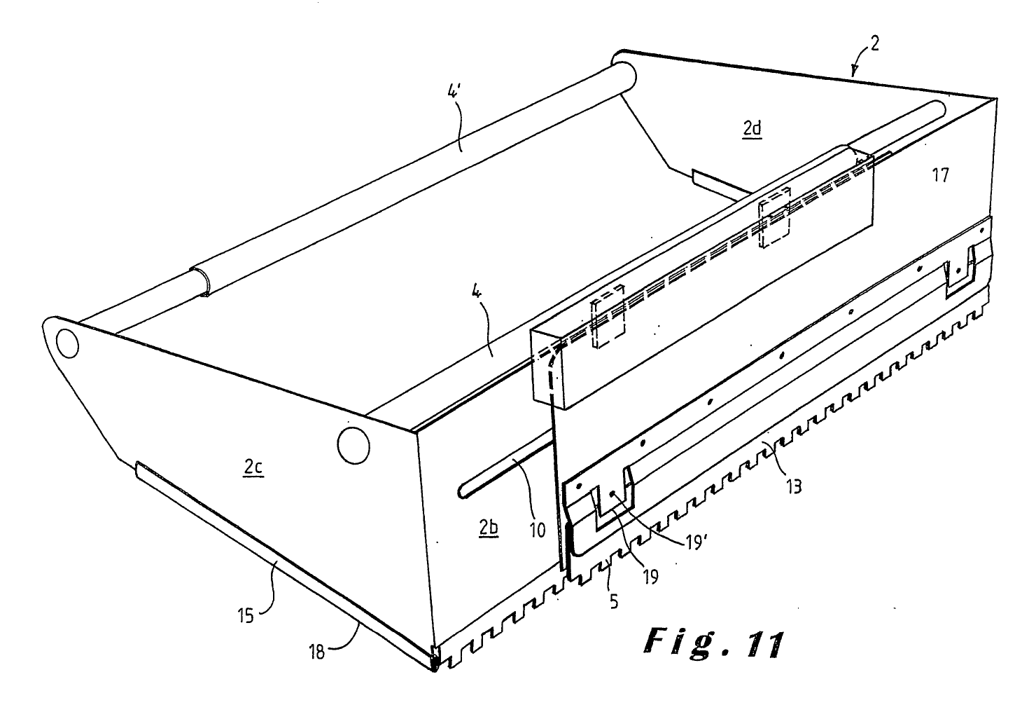

FIG. 11 is also a perspective view of the most preferential embodiment of the device according to the invention in which the counterweight can be seen.

As illustrated in FIGS. 1 and 2, the adhesive spreading device 1 of the invention comprises a housing 2 which, in a preferred embodiment, is rectangular and open on its lower face and on its upper face. Its dimensions are variable according to the dimensions of the rooms in which a floor covering has to be pasted. The width of the housing 2 is generally between 30 cm and 80 cm and preferably between 40 cm and 72 cm.

The user fills the housing 2 with adhesive (in general, the amount of adhesive poured into the housing is approximately 25 kg), and then disposes the bar 3 on the handle 4 of the housing 2, as illustrated in FIG. 2. The bar 3 is provided with a lever 7 in order to be held in the hand by the user and with an end 8 opposite to the lever 7, the shape of which allows removable fitting onto the handle 4 of the housing 2. Moreover, the bar 3 can be inclined according to a variable angle, and this bar 3 is, preferably, telescopic in order to be adaptable to the height of the user.

FIG. 3 illustrates an adhesive spreading device 1 whose housing 2 comprises a first 2b and a fourth 2a vertical wall, and a second 2c and a third 2d vertical wall. In this simple embodiment, the first vertical wall 2b has a toothed lower edge 5 and the fourth vertical wall 2a has a handle 4 on its external face.

Persons skilled in the art will understand that all the vertical walls 2a, 2b or 2c, 2d can comprise an upper and/or lower edge provided with teeth 5.

As can be seen in FIG. 4a, the teeth 5 are either integral with the lower edge of a vertical wall 2a, 2b, 2c, 2d of the housing 2, or disposed on a plate 13 (see FIG. 4b) that is affixed, with adjustable fixing means, such as for example wing bolts 11, or by a clamping system, against the vertical wall 2a, 2b, 2c, 2d of the housing 2 so that the teeth 5 disposed on the plate 13 are exposed at the floor with a height adapted to the thickness of adhesive 6 that the user wishes to spread on the floor.

Moreover, the teeth can have various dimensions chosen from amongst the following: 6 mm×6 mm, 8 mm×8 mm, 8 mm×10 mm, 10 mm×12 mm or 12 mm×14 mm in the case of quadrangular teeth. They have a diameter of 6, 8, 10, 12, 14 in the case of semicircular, semi-elliptical, etc. teeth. They can also be spaced differently from one another, from a panel or from one edge to the other.

The height of the teeth can be set either (FIG. 4a) by means of a panel 14 which is disposed inside the housing 2 against the toothed vertical wall, said panel being fixed with eyelets so as to be able to slide up and down and thus vary the height of the teeth 5, or (FIG. 4b) by raising the plate 13 which comprises the teeth 5, and consequently the height of the teeth 5 will be set by the vertical wall on which the plate 13 is fixed. It must obviously be understood that the panel 14 can also be disposed on the internal face of the plate 13 in order to adjust the height of the teeth 5.

Another embodiment of the adhesive spreading device of the invention makes provision that each housing 2 has fixed tooth dimensions and the user therefore chooses the housing 2 as a function thereof.

As mentioned previously, a supplementary embodiment makes provision that the housing 2 is provided with teeth 5 on the lower edge and on the upper edge of the vertical wall 2b opposite the vertical wall 2a provided with a handle 4.

Preferably, the teeth on the lower edge have dimensions different from those of the teeth on the upper edge. Thus, the user has only to turn the housing 2 upside down when he wishes to use one of the two types of teeth.

FIG. 5 illustrates an embodiment which is particularly preferential in particular for the application of a first layer.

The vertical lateral walls 2c, 2d have a lower edge 15 comprising a protuberance 16 extending downwards folded upwards provided to allow easier sliding of said housing over said floor during said adhesive spreading. This fold 16 at the bottom 15 of the vertical wall 2c, 2d acts as a runner since, like wood, all steel, stainless steel and similar has a direction. This direction makes it possible to define one surface smoother than another which will, during pulling of the device according to the invention, allow the latter to slide directly on the floor in order to alleviate the strain on persons skilled in the art.

Advantageously, the vertical walls 2c, 2d have a height greater than that of the vertical walls 2a, 2b, and they therefore come down lower than the vertical walls 2a, 2b. The weight of the adhesive spreading device according to the invention is mainly distributed over the abovementioned folds 16 making it possible to reduce the rubbing of the walls 2a, 2b which do not have this protuberance 15. Moreover, this device allows a pre-pasting that is also referred to as application of a first layer of a thickness which will be relatively equal to the difference in height between a lower part of the teeth 5 of the vertical wall 2a, 2b and the support surface 18 of the fold 16 of the vertical wall 2c, 2d.

FIG. 6 illustrates the bar 3, provided with the lever 7 in order to be held in the hand by the user and with an end 8 opposite to the lever 7, the shape of which allows a removable association on the handle 4 of the housing 2. Moreover, the bar 3 can be inclined according to a variable angle, and this bar 3 is, preferably, telescopic in order to be adaptable to the height of the user.

Advantageously, the vertical wall 2c, 2d comprises a handle 4 identical to or different from the handle 4 disposed on said vertical wall 2a, 2b. This makes it possible to quickly interchange the fourth 2a and the first 2b and the second 2c and the third 2d vertical wall without dismantling the device 1 since it is consequently sufficient to turn it by a quarter of a turn with respect to the direction of pulling of the device 1 according to the invention.

The adhesive spreading device 1 according to the invention makes provision that the housing 2 is, preferably, made from stainless steel //(15/10, 18/10), so as to be sturdy, washable and sufficiently heavy so as to not lift up when the user pulls it in order to spread the adhesive.

Other materials can be used such as galvanised steel, ceramic or a rigid plastic.

The adhesive spreading device 1 of the invention is mainly used within the context of laying tiling on the floor but other floor coverings require the use of adhesive, such as carpet, linoleum, cork or pasted wooden floors.

FIGS. 7a to 7d illustrate the possibility of disposing a masking plate 9 which makes it possible to determine six different laying widths according to the size of the tiles that have to be pasted. Thus an adhesive spreading device 1 of the invention can have dimensions ranging from 30 cm to 80 cm and preferably from 40 cm to 72 cm, this comprising all possible intermediate sizes.

FIG. 8 illustrates a method of setting the width of the housing 2 by means of a wing bolt 11 that slides in a channel 10 so as to narrow or widen the toothed edge.

The adhesive spreading device 1 of the invention can be provided with castors 12, as illustrated in FIG. 9, to facilitate pulling.

Where the user wishes to paste tiles with large dimensions (at least 40 cm×40 cm), it is not necessary to also paste the lower face of the tile before putting it down on the layer of adhesive spread on the floor by means of the adhesive spreading device 1 of the invention.

The adhesive spreading device 1 of the present invention therefore makes it possible to eliminate the pasting of large tiling tiles whilst obtaining as effective an adhesion thereof on the floor.

FIG. 10 illustrates the preferential embodiment of the device according to the invention. In this embodiment, the housing 2 comprises three vertical walls 2b, 2c, 2d. The first wall is adjustable in length by means of a groove 10 in which there slides a fixing means, for example a wing bolt or any other fixing means, such as a clip or some other means.

The teeth 5 are situated on an interchangeable plate 13 of adjustable length. The interchangeable plate is fixed to the first wall 2b by mutual embedding means 19 and 19′.

The device comprises a U-shaped component 15 comprising an upper opening and a lower support surface 18. The lower edges of the second 2c and third 2d vertical walls of the housing 2 are slid into the U-shaped component 15 through the upper opening thereof.

This is equivalent to equipping the housing 2 with runners 15 in order to delay the wear of the teeth 5 and facilitate the sliding of the device according to the invention since the support surface 18 rests on the floor and, as for the teeth 5, these are not in contact with the floor.

The handle 4 connects the upper edges of the second 2c and third 2d vertical walls. The handle is adjustable in length.

A second handle 4′, also adjustable in length, connects the upper edges of the second 2c and third 2d vertical walls.

Disposing the handle at this location has made it possible to obtain a device of greater rigidity; this handle in effect acts as a strengthening bar, it is preferably adjustable, and can be drawn out or closed up at the same time as the vertical walls.

According to requirements, the user can use the first situated towards the rear or the second situated for example towards the front and affix thereto the telescopic bar assisting pulling such as that depicted in FIG. 6.

FIG. 11 shows the counterweight 17 that is provided in order to be disposed in the region of the first vertical wall 2b, preferably on the upper edge of the first vertical wall 2b.

In the case of a very large user or a heavy and very thick adhesive, it can be advantageous to have a weight to be affixed to said first wall in order to avoid unexpected lifting. The weight is disposed straddling the wall by appropriate fixing means.

It must be understood that the present invention is in no way limited to the embodiments described above and that many modifications can be made thereto without departing from the scope of the accompanying claims.

1. Device (1) for spreading adhesive for floor coverings, comprising a quadrangular housing (2) open at least on its lower face, said housing (2) comprising at least a first (2b), a second (2c) and a third (2d) vertical wall, said second (2c) and third (2d) vertical walls being opposite one another and each of said vertical walls comprising a lower edge and an upper edge, said housing (2) comprising at least one handle (4) and at least said first vertical wall comprising teeth (5) on the lower edge, wherein said vertical walls (2b, 2c, 2d) have an adjustable length provided in order to be adapted to a tile dimension.

2. Device (1) for spreading adhesive for floor coverings according to claim 1, also comprising a fourth vertical wall (2a).

3. Device (1) for spreading adhesive for floor coverings according to claim 1, wherein at least one of said vertical walls comprises teeth on the upper edge.

4. Device (1) for spreading adhesive for floor coverings according to claim 1, also comprising a U-shaped component (15) comprising an upper opening and a lower support surface (18), said U-shaped component being provided in order to be disposed on the lower edge of said second and third vertical walls of said housing.

5. Device (1) for spreading adhesive for floor coverings according to claim 1, wherein said second (2c) and third (2d) vertical walls have, at least at the lower edge, a protuberance (15) extending downwards folded upwards, said protuberance having a lower support surface (18).

6. Device (1) for spreading adhesive for floor coverings according to claim 1, wherein said lower support surfaces (18) of said second (2c) and third (2d) walls are situated at least lower than said lower edge of said first wall (2b) and/or of the fourth wall (2a), when the device is assembled.

7. Device (1) for spreading adhesive for floor coverings according to claim 1, wherein said teeth (5) are situated on at least one edge of an interchangeable plate (13), which is provided in order to be fixed at the edge of at least one of said vertical walls.

8. Device (1) for spreading adhesive for floor coverings according to claim 1, wherein said interchangeable plates (13) have an adjustable length.

9. Device (1) for spreading adhesive for floor coverings according to claim 1, wherein said teeth (5) are integral with said edge of at least one of said vertical walls.

10. Device (1) for spreading adhesive for floor coverings according to claim 1, wherein said teeth (5) have a height and/or a width and/or a spacing which are different from one edge to the other and/or from one interchangeable plate (13) to another.

11. Device (1) for spreading adhesive for floor coverings according to claim 1, wherein at least said fourth (2a) vertical wall comprises said handle (4) on an external face.

12. Device (1) for spreading adhesive for floor coverings according to claim 1, wherein at least two vertical walls comprise an identical or different handle (4) on the external face.

13. Device (1) for spreading adhesive for floor coverings according to claim 1, wherein said handle is adjustable in length.

14. Device (1) for spreading adhesive for floor coverings according to claim 1, wherein said handle (4) connects the upper edges of the second (2c) and third (2d) vertical walls.

15. Device (1) for spreading adhesive for floor coverings according to claim 1, wherein a second handle, adjustable in length, connects the upper edges of the second (2c) and third (2d) vertical walls.

16. Device (1) for spreading adhesive for floor coverings according to claim 1, also comprising a bar (3), one end (8) of which has a shape provided to be associated with the handle (4) of the housing (2), in an articulated and removable manner.

17. Device (1) for spreading adhesive for floor coverings according to claim 16, wherein the bar (3) is telescopic.

18. Device (1) for spreading adhesive for floor coverings according to claim 1, wherein the teeth (5) have a height (h) and a width (w) in mm (h×w) chosen from amongst the following: 6×6, 8×8, 8×10, 10×12, 12×14.

19. Device (1) for spreading adhesive for floor coverings according to claim 1, wherein the teeth (5) have a spacing by a distance (in mm) chosen from amongst the following: 6, 8, 10, 12 and 14.

20. Device (1) for spreading adhesive for floor coverings according to claim 1, wherein the length of said vertical walls lies in the range 30 cm to 80 cm, and preferably 40 cm to 72 cm.

21. Device (1) for spreading adhesive for floor coverings according to claim 1, wherein the housing (2) is also provided with a masking plate (9) provided to be affixed to the internal face of at least one of said vertical walls at the level of the teeth (5), the masking plate (9) being provided to mask at least one of said teeth (5).

22. Device (1) for spreading adhesive for floor coverings according to claim 1, wherein a panel (14) is provided to be affixed to the internal face of at least one of said vertical walls provided with teeth (5), the panel (14) being provided to slide vertically so as to vary the height of the teeth (5).

23. Device (1) for spreading adhesive for floor coverings according to claim 1, wherein a counterweight (17) is provided to be disposed in the region of the first vertical wall (2b), in particular on the upper edge of said first vertical wall (2b).

24. Device (1) for spreading adhesive for floor coverings according to claim 1, being manufactured from a material chosen from the group consisting of stainless steel, galvanised steel, rigid plastic, ceramic and mixtures thereof.
